(19) United States
(12) Patent Application Publication
(10) Pub. No.: US 2016/0117679 A1
(43) Pub. Date: Apr. 28, 2016

(54) Automated Payment Information Update With Vendors

(71) Applicant: Total System Services, Inc., Columbus, GA (US)

(72) Inventors: Francis Raymond Braski, Columbus, GA (US); Gilbert Strickland, Phenix City, AL (US); Christen J. Colson, Cumming, GA (US); David Hehman, Pine Mountain, GA (US)

(21) Appl. No.: 14/525,749

(22) Filed: Oct. 28, 2014

(51) Int. Cl. G06Q 20/40; G06Q 20/36

(52) U.S. Cl. CPC G06Q 20/405; G06Q 20/36; G06Q 20/401

(57) ABSTRACT

A wallet integration server generates a list of one or more vendors for presentation to a user responsive to a successful authentication of the user. Upon receiving a selection of at least one vendor from the list of vendors by the user, the wallet integration server generates and transmits a validation request to the at least one vendor for validating the user. Responsive to a successful validation of the user by the at least one vendor, the wallet integration engine generates and transmits a message comprising payment information associated with the user to the at least one vendor. Further, the wallet integration server receives a notification confirming receipt of the payment information by the at least one vendor.

### FIELD OF INVENTION

This invention relates generally to payment systems, and more particularly, to a system, apparatus and method for automated payment information update with vendors.

### BACKGROUND

On a daily basis, consumers make online purchases from a wide array of vendors. Often, payment card information of the consumers is securely stored by the vendors to relieve consumers from having to re-enter the payment card information for each purchase. However, if the payment card information of the consumers change for any given reason, such as reissue of payment card due to security breach, expiration of payment card, etc., conventional technology may not automatically update the new payment card information with the vendors. Instead, conventional technology may require the consumers to manually go to each vendor website and enter the new payment card information. Creating, updating, or otherwise changing payment information, especially on-line, for each vendor may be a time-intensive and laborious exercise.

In addition, if the consumer forgets to update the information, or forgets all of the places (e.g., merchant websites, recurring payment sites, etc.) the payment information needs to be updated, interruption of services may occur and additional fees may be charged, not to mention the loss of sale to the vendor. For example, a failure to update the card information stored by the merchant may affect and interrupt Automated Clearinghouse (ACH) transactions, which may further lead to additional fees incurred due to non-payment. Such outcomes may be undesirable for the consumer and may deter consumers from making online purchases with vendors, thereby resulting in loss of sales and revenue to the vendors.

Retaining a ‘top of wallet’ position may be highly desired by financial institutions and card issuers as they desire to have their card utilized the most. Top of wallet is defined as the position of a customer/purchasers credit and/or debit card that is selected to make the payment. Undesirable results resulting from failure to update payment information associated with a payment card, such a non-payment fine, declined purchases, etc., may force a consumer to replace the current payment card with another payment card, for example a competitor payment card, and thereby resulting in a loss of the coveted ‘top of wallet’ position for the current payment card which in turn may result in loss of valuable business to the associated financial institution. Therefore, there is a need for a technology that addresses the above-mentioned shortcomings.

### SUMMARY

The present disclosure can address the above-mentioned needs by use of a system, apparatus, and method for automated payment information update with vendors. Automated payment information update with vendors can ensure cardholders an uninterrupted availability of a payment card for purchases and payments with multiple merchants by automatically pushing and/or updating payment information (e.g., payment card details) with the multiple vendors in the event a new payment card is issued and/or when a payment card is replaced or re-issued. In addition to automatically updating payment information, the system, apparatus, and method for automated payment information update with vendors may provide a reminder service to the cardholders to update their payment information when the cardholders are issued new cards, or when their cards are replaced, re-issued, or renewed. The reminder service relieves the cardholders from having to remember to update their payment information and all the vendors that need to updated with the payment information. In addition, the system, apparatus, and method for automated payment information update with vendors may provide the cardholders with an option to select, assign and/or set a payment card to be used as the primary or default choice of payments, thereby enabling the payment card, financial institution and/or the card issuer to secure the much coveted ‘much coveted ‘top of wallet’ status.

In light of the above discussion, the system, apparatus, and method for automated payment information update with vendors effects an improvement in the field of payment systems and e-commerce by providing a seamless and convenient solution to consumers for (a) hassle free management of the consumers payment information with multiple vendors, (b) uninterrupted payment service, and (c) maintain a ‘top of wallet’ status for financial institutions and/or card issuers. Accordingly, the solution encourages and facilitates more online purchases and/or transactions which in turn drive online revenue for businesses.

Online purchases and/or transactions as used herein can include, but are not limited to, goods and/or services purchase such as purchase through Amazon, E-Bay, etc., purchases using PayPal®, and/or recurring bill payment such as electric bill payment, cable bill payment, insurance and loan payments, and so on.

In an exemplary embodiment, a system includes a wallet integration server that provides services associated with an automated payment information update with vendors. The wallet integration server may provide a client application through which the services of the wallet integration server may be accessed. In one example embodiment, the client application of the wallet integration server may be integrated with a financial institution application, such as a mobile or online banking application. In another example embodiment, the client application of the wallet integration server can be integrated with any number of configurable online shopping sites, mobile wallets, donation and payment buttons, and/or checkout systems, such as E-Bay, Google Wallet, Amazon, Facebook, PayPal®, Netflix, Redbox, Sony PlayStation Network, Xbox Live Gold, Nintendo, and so on. In yet another example embodiment, the client application may be provided as a standalone application that is distributed for download and install through application distribution platforms, such as Google Play, App store in Apple iTunes, Amazon Appstore, Samsung Apps Store, and so on.

In an example embodiment, when executed, the client application instructs a computing device associated with the user (e.g., smart phone, tablet, PDA, desktop computer, etc.) to prompt the user to enter credentials associated with the user for authenticating the user. Credentials inputted by the user may be transmitted by the computing device associated with the user (herein ‘user computing device’) to a financial institution server and/or an authentication agent configured to authenticate the user. In some embodiments, the credentials may be transmitted to the wallet integration server for authenticating the user. On the basis of the result of the authentication, i.e., if the authentication of the user is successful, the wallet integration server generates a list of one or more vendors (e.g., major vendors and/or local vendors) for presentation to the user. The list of one or more vendors may be a default list of vendors, a customized list of vendors, or a combination of both. In one example embodiment, a customized list may be generated from a group of vendors pre-selected by the users at a time of setup or registration. In another example embodiment, the customized list may be generated based on one or more parameters and/or analytics results, such as location of the user, an analysis of bank transaction history of the user, an analysis of user's computing device for evidence of using certain vendor services. In some embodiments, in addition to generating the list, the wallet integration server 102 may sort, organize, and/or categorize the list of one or more vendors, based on various parameters, such as user preference, how often a vendor service is used by a user, number of transactions with the vendor, and so on.

Responsive to generating the list of the one or more vendors, the wallet integration server transmits the list to the user computing device which in turn presents the list to the user. Further, the user computing device prompts the user to select at least one vendor from the list of one or more vendors. Responsively, the user computing device receives data representative of the at least one vendor selected by the user. Data representative of the at least one vendor is then transmitted to the wallet integration server.

Upon receiving the data representative of the at least one vendor selected by the user, the wallet integration server generates and transmits a validation request to the at least one vendor for validation of the user by the vendor. In particular, upon receiving the data representative of the at least one vendor selected by the user, the wallet integration server may generate one or more application programming interface (API) calls associated with the vendor to route the user to a website of the vendor. The execution of the one or more API's associated with the vendor may cause a validation webpage or validation instructions associated with the vendor to be presented to the user via the user computing device. Further, the user computing device prompts the user to input user identification information for validation by the vendor. Responsively, the user inputs user identification information which is transmitted to the at least one vendor to validate the user. For example, if the at least one vendor selected by the user is PayPal®, the wallet integration server generates one or more PayPal® API calls which when executed, presents a PayPal® login page to the user on the users computing device. Once the user enters the user's PayPal® login information, PayPal® validates the user based on the login information provided by the user.

Once the user is validated, the at least one vendor transmits a result of the validation to the wallet integration server. Responsive to a successful validation, the wallet integration server updates a vendor-consumer relationship data corresponding to the user by associating the user with the at least one vendor. Further, the wallet integration server may retrieve payment information associated with the user that is stored in a database associated with the wallet integration server or an external database. In one embodiment, the payment information retrieved by the wallet integration server may be associated with a payment account or payment instrument identified by the user as a primary account or primary card that is set as a default choice for payments. In another embodiment, the payment information retrieved by the wallet integration server may be associated with secondary payment account or secondary payment instrument.

Responsive to retrieving the payment information, the wallet integration server encrypts the payment information and transmits the encrypted payment information to the at least one vendor. The at least one vendor receives the encrypted payment information, decrypts the encrypted payment information, and stores or updates the payment information associated with the user. In some embodiments, if a secure communication link exists between the wallet integration server and the vendor, the payment information may not be encrypted. In either case, upon storing and updating the payment information associated with the user, the vendor transmits a notification to the wallet integration server, the user computing device, and the financial institution notifying a successful receipt of the payment information. In some embodiments, the wallet integration server transmits the notification to the user computing device upon receipt of the notification from the vendor. Further, the user computing device presents the notification to the user.

Each time the payment information associated with the user changes, for example when new payment card is issued, address linked to the payment account changes, a payment card is replaced, renewed, or re-issued, and so on, the wallet integration server detects the vendors that the user makes online purchases with, and guides the user through updating the payment information with the vendors. Further, the wallet integration server can detect an expiration date associated with a payment card and send reminders to the user prior to expiration of the current payment card. In some embodiments, when prior authorization has been received from the user to automatically update the payment information whenever the payment information changes, the wallet integration server may refrain from sending reminders to the user. However, each time a vendor is updated with payment information associated with a user, a notification may be sent to the user confirming receipt of the payment information by the vendor.

These and other aspects, features, and embodiments of the disclosure will become apparent to a person of ordinary skill in the art upon consideration of the following brief description of the figures and detailed description of illustrated embodiments.

### BRIEF DESCRIPTION OF THE FIGURES

Example embodiments are illustrated by way of example and not limitation in the figures of the accompanying drawings, in which:

FIGS. 1A and 1B (collectively ‘FIG. 1’) illustrate one or more example operational environments of the payment information update system in accordance with an example embodiment;

FIG. 2 illustrates a block diagram of the wallet integration server of FIG. 1 in accordance with an example embodiment;

FIG. 3 is a flowchart that illustrates an operation of the wallet integration server in association with an automated payment information update in accordance with an example embodiment;

FIGS. 4A-4D (collectively ‘FIG. 4’) is a flowchart that illustrates an operation of payment information update system in accordance with an example embodiment;

FIG. 5 illustrates one or more example user interfaces associated with the payment information update process in accordance with an example embodiment;

Many aspects of the invention can be better understood with reference to the above drawings. The elements and features in the drawings are not to scale; emphasis is instead being placed upon clearly illustrating the principles of example embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION

Disclosed are a system, apparatus, and method for automated payment information update with vendors. Before discussing the embodiments directed to the system, apparatus, and method and system for automated payment information update with vendors, it may assist the reader to understand the various terms used herein by way of a general description of the terms in the following paragraphs.

The term ‘credentials’ as used herein may generally refer to any appropriate form of identification associated with a user. Credentials associated with a user may include, but are not limited to, name of the user, personal identification number, password, biometric identifiers, finger prints, retinal pattern, iris pattern, social security number, driver license number, e-mail address, and so on. In some embodiments, the credentials can include a combination of one or more identifiers associated with the user or a combination of identifiers associated with the user and identifiers not associated with the user. For example, the credentials may include a combination of username, password, and a unique number displayed to the user. In another example, the credentials may include a combination of username, password, and mother's maiden name.

The term ‘vendor’ as used herein may generally refer to any appropriate entity that offers services and/or goods to consumers for purchase. In a preferable embodiment, the vendors may have electronic commerce capability that allows consumers to directly or indirectly buy goods or services from the vendor over the Internet using a web browser. In one example, vendors can include wholesale merchants, retail merchants, and/or e-commerce payment businesses, such as Amazon, Facebook, Google, EBay, PayPal®, Apple iTunes, Google Play, Netflix, Redbox, and so on. In another example, vendors can include service providers with which a consumer may have recurring payment arrangement, such as electric power company, cable provider, Internet service providers, health clubs, online gaming sites: Nintendo, Sony PlayStation Network (PSN), and Xbox Live Gold, and so on. In yet another example, vendors can include mobile payment and/or digital wallet service providers, such as Google Wallet, Apple Pay, and so on.

The term ‘payment information’ as used herein may generally refer to any appropriate information associated with a payment mechanism or a non-cash payment instrument. Example payment information may include, but is not limited to, bank account number, routing number, check number, credit card number, debit card number, expiration date, 3-digit or 4-digit code associated with the payment card, name on the payment card, address associated with the payment card, and so on. One or ordinary skill in the art can understand and appreciate that the example payment information listed above is not limiting, and can include any appropriate data that can be used for facilitating a payment transaction.

The term ‘transaction history’ as used herein may generally refer to any appropriate transaction data that associates a consumer to a vendor. In a preferable embodiment, the transaction history can include financial transaction data of a consumer, such as a bank transaction history. In another embodiment, the transaction data can include a web browser history of a consumer, and on provided the consumer has provided authorization for such access.

The term ‘user identification information’ as used herein may generally refer to any form of identification associated with the user that can be used by a vendor to identify the user. Example user identification information can include, but is not limited to, personal identifiers such as name, address, social security number, passwords, username, e-mail address, biometric identifiers, a combination of one or more identifiers, and so on.

The term ‘validation page’ as used herein may generally refer to any appropriate web page that requests user identification information. In particular, the validation page may be a web page associated with the vendor and the user identification information may be used by the vendor to identify the user and grant access to various vendor services. Examples can include any appropriate webpage that a vendor uses for validation, such as PayPal® login page, Facebook login page, Amazon login page, Comcast login page, etc.

In an exemplary embodiment, in response to a successful authentication of a user, the wallet integration server may generate a list of one or more vendors for presentation to the user. The authentication of the user may be performed internally by the wallet integration server or externally by an authentication agent and/or a financial institution server, and the result of the authentication may be forwarded to the wallet integration sever. The generated list of one or more vendor may be presented to the user via a user computing device, and the user may select at least one vendor that has to be updated with payment information associated with the user. In response to selecting the at least one vendor by the user, the wallet integration server may generate and transmit a validation request to at least one vendor for validating the user by the at least one vendor. In response to a successful validation of the user by the at least one vendor, the wallet integration server may generate and transmit an encrypted message comprising the payment information associated with the user to the at least one vendor. Further, the wallet integration server may receive a notification from the at least one vendor that confirms a receipt of the payment information by the at least one vendor.

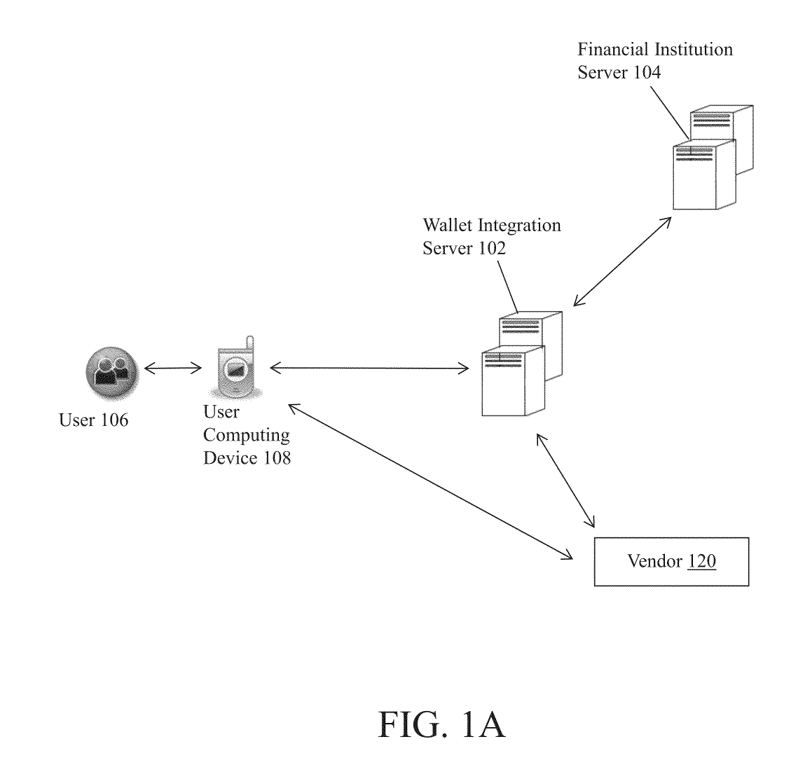

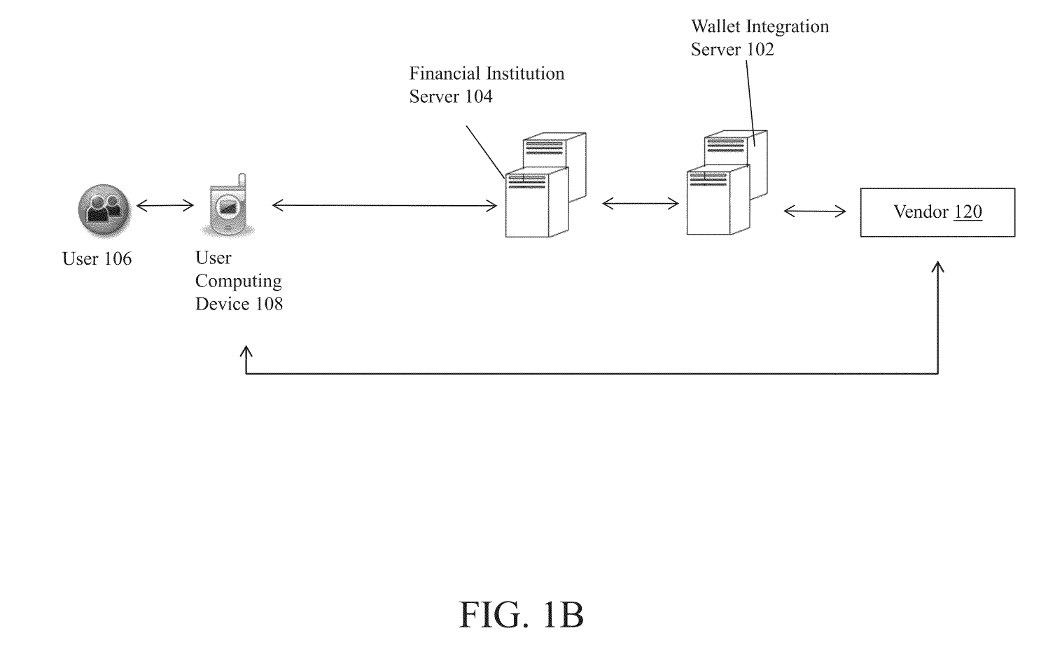

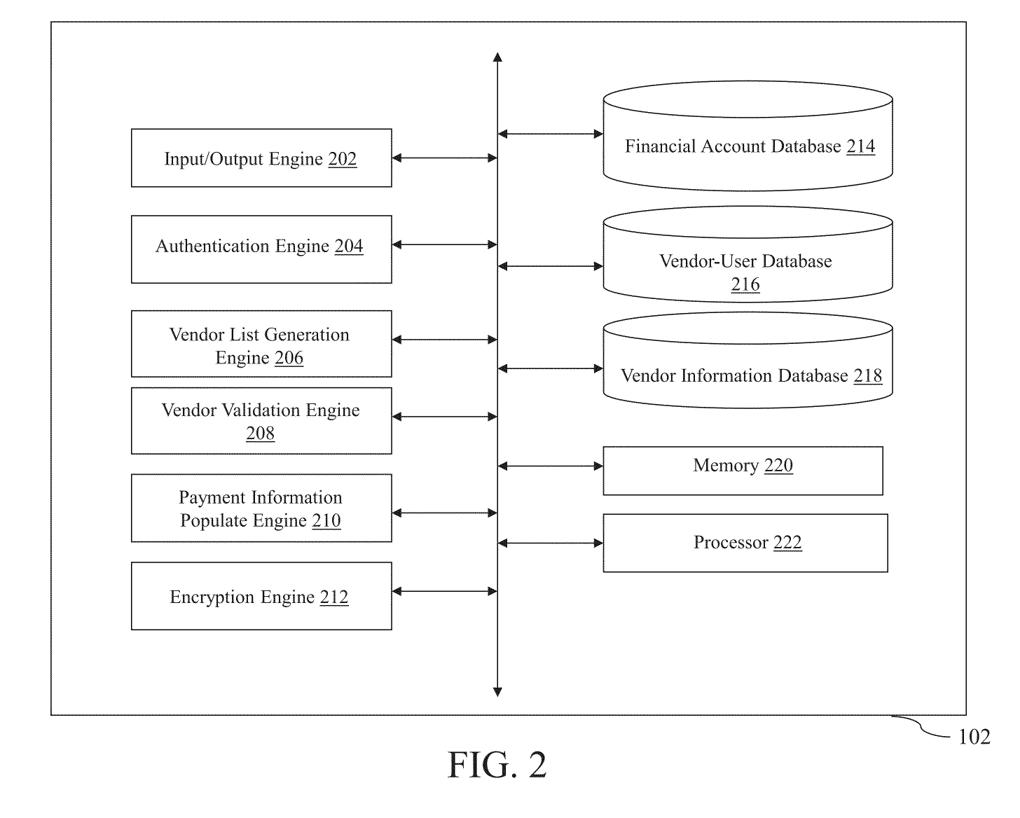

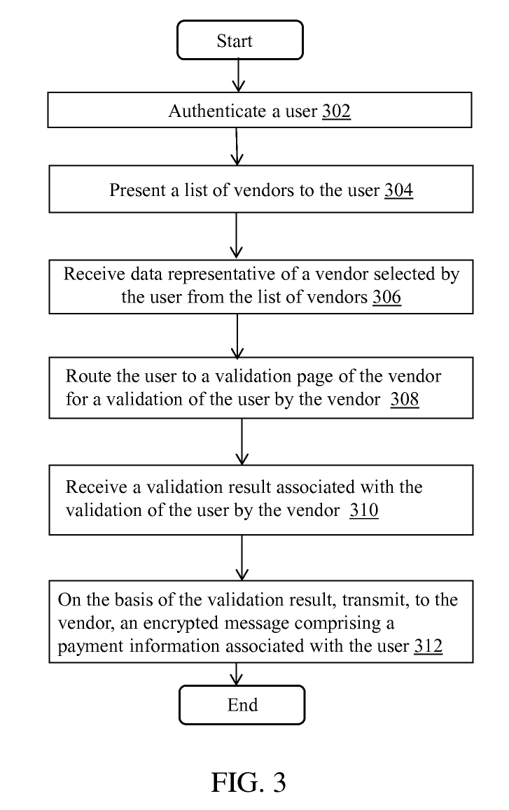

Technology associated with the system, apparatus, and method for automated payment information update with vendors will now be described in greater detail with reference to FIGS. 1-5, which describe representative embodiments of the present invention. First, FIGS. 1A and 1B will be discussed in the context of describing a representative operating environment associated with the automated payment information update system according to certain exemplary embodiments of the present invention. FIG. 2 will be discussed, making exemplary reference back to FIG. 1 as may be appropriate or helpful. Further, FIGS. 3-5 will be discussed, making exemplary reference back to FIGS. 1 and 2 as may be appropriate or helpful.

The following paragraphs describe various embodiments of the method, apparatus, and system for automated payment information update with vendors. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

Further, the present invention may be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

Moving to FIGS. 1A and 1B (collectively referred to as ‘FIG. 1’), these figures illustrate one or more example operational environments of the payment information update system in accordance with an example embodiment. In particular, FIG. 1 illustrates a user 106, a user computing device 108, a wallet integration server 102, a financial institution server 104, and vendor 120.

Referring to FIG. 1, an automated payment information update engine configured to provide services associated with automated payment information update with vendors may reside on a server computer, such as the wallet integration server 102. The wallet integration server 102 may have client applications configured to access the wallet integration server 102. In one embodiment, the client application may be integrated with a financial institution system or with any number of configurable online shopping sites, mobile wallets, donation and payment buttons, and/or checkout systems. In said embodiment where the client application is integrated with other external systems, the client application may be offered as a service associated with the system with which the client application is integrated. For example, if the client application is integrated with an online payment system of a bank, the client application may be offered as a feature of the bank's online payment system. In another embodiment, the client application may be offered as a standalone application that can reside on a user computing device 108, and may be implemented as software, hardware, or a combination of both.

In one embodiment, the user computing device 108 may be communicably coupled to the wallet integration server 102 via a private and/or public network over a wired and/or wireless communication link. In another embodiment where the client application of the wallet integration server 102 is integrated with a financial institution system, the user computing device 108 may be communicably coupled to the financial institution server 104 (shown in FIG. 1B) which in turn may be communicably coupled to the wallet integration server 102. In said embodiment where the client application of the wallet integration server 102 is integrated with a financial institution system, the user computing device 108 may access the wallet integration server 102 indirectly through the financial institution server 108 via client applications associated with the financial institution in combination with the client application of the wallet integration server 102. In addition to being communicably coupled to the wallet integration server 102 and/or the financial institution server 104, the user computing device 108 may also be communicably coupled to one or more vendors 120.

A user 106 may access the wallet integration server 102 and the services offered by the wallet integration server 102 using the user computing device 108. Example user computing devices 108 can include, but are not limited to, a mobile phone, a smart phone, a laptop, a desktop computer, a tablet, a personal digital assistant, and any appropriate data processors and/or computing devices having network and display capabilities. Even though the user computing device 108 is associated with accessing the wallet integration server in the present disclosure, one of ordinary skill in the art can understand and appreciate that the user computing device 106 can be used for numerous other purposes such as Internet access, phone calls, etc., without departing from the broader scope of this disclosure.

The user computing device 108 may be configured to send data to and/or receive data from to the wallet integration server 102, the financial institution server 104, and or the vendor(s) 120. Example data that may be sent includes, but is not limited to, user credentials for authentication of the user 106, user identification information for validation of the user 106 by the vendor 120, a selection of one or more vendors that the need to be updated with payment information associated with the user 106, assignment of a payment card as a default payment card, etc. Example data that is receive may include, but is not limited to, a list of one or more vendors, a notification of receipt of payment information by the vendor 120, a validation page from the vendor, etc. One of ordinary skill in the art can understand and appreciate that the example data mentioned above are not limiting, and any other appropriate data associated with automated payment information update service are not outside the broader scope of this description.

As illustrated in FIG. 1, automated payment information update system may include a financial institution server 104 that is communicably coupled to the wallet integration server 102. The financial institution server 104 may be configured to provide the wallet integration server 102 with payment information associated with the user, provided the user is a customer of the financial institution associated with the financial institution server 104. The financial institution server 104 may automatically push the payment information associated with the user to the wallet integration server 102 or provide the payment information associated with the user upon request from the wallet integration server 102. In either case, responsive to receiving the payment information associated with the user, the wallet integration server 102 may store the payment information in a database (shown in FIG. 2) associated with the wallet integration server 102. In addition to providing payment information associated with the user, the financial institution server 104 is configured to authenticate the user 106 based on credentials associated with the user (herein ‘user credentials’). The user credentials may be transmitted to the financial institution server 104 directly from the user computing device 108 (shown in FIG. 1B) or through the wallet integration server 102 (shown in FIG. 1A) depending on whether the client application is integrated with the financial institution system or provided as a standalone application. Authenticating the user 106 may ensure that the user 106 is a customer of a financial institution associated with the financial institution server 104. Even though user authentication is described as a function of the financial institution server 104, one of ordinary skill in the art can understand and appreciate the user credentials can also be authenticated by any other appropriate authentication agent without departing from a broader scope of this disclosure.

In addition to being communicably coupled to the user computing device 108 and the financial institution server 104, the wallet integration server 102 may be communicably coupled to one or more vendors 120 via a private and/or public network, as illustrated in FIG. 1. The one or more vendors 120 may be configured to receive a validation request from the wallet integration server 102 and responsively present a validation page to the user 106 on the user computing device 108. The communication between the wallet integration server 102, the vendor 120, and the user computing device 108 to present the validation page to the user 106 may include a series of API calls, e.g., vendor API's. In addition to presenting the validation page, the vendor 120 may be configured to validate the user based on user identification information received in response to presenting the validation page to the user. Further, the vendor 120 may be configured to transmit a validation result to the wallet integration server 102 and receive payment information associated with the user 106 from the wallet integration server 102. If the payment information is encrypted, then, the vendor 120 can decrypt the encrypted payment information. Upon successful receipt of the payment information, the vendor 120 sends notifications to the user computing device 108, the wallet integration server 102, and the financial institution server 104.

As described above, the wallet integration sever 102 may receive a user authentication result from either the financial institution server 104 and/or an authentication agent. If the user authentication is successful, the wallet integration server may generate a list of one or more vendors for presentation to the user 106. Responsive to presenting the list of the one or more vendors and responsive to receiving a selection of at least one vendor 120 from the list, the wallet integration server 102 may generate API calls to route the user 106 to a validation page of the selected at least one vendor 120. In some embodiments, the at least one vendor 120 may be chosen from outside the list presented to the user. For example, along with the list, the user may be presented with an option to input a vendor that is not included in the list. In either case, once the user 106 is routed to a validation page of the at least one vendor, the user may enter user identification information for validation by the at least one vendor. The result of the vendor validation may be transmitted to the wallet integration server 102. If the user is successfully validated by the at least one vendor, the wallet integration server 102 may transmit payment information associated with the user to the at least one vendor, and receive a notification upon successful receipt of the payment information by the at least one vendor. In addition, in some embodiments, the wallet integration server 102 may be configured to alert the user 106 or transmit reminder messages to the user 106 to notify the user 106 of an impending expiration date associated with a payment instrument, such as a payment card. If a user 106 has more than one payment card, the wallet integration server 102 may also allow the user 106 to select one of the payment cards as a primary card or default card to be used for purchases. The operation of the wallet integration server 102 and the automated payment information update system will be described in greater detail in association with FIGS. 3-5, and a hardware implementation of the wallet integration server 102 will be described in greater detail below in association with FIG. 2.

Turning to FIG. 2, this figure illustrates an example block diagram of the wallet integration server 102 of FIG. 1 in accordance with an example embodiment. In particular, FIG. 2 illustrates an input/output engine 202, an authentication engine 204, a vendor list generation engine 206, a vendor validation engine 208, a payment information populate engine 210, an encryption engine 212, a financial information database 214, a vendor-user database 216, a vendor information database 218, a memory 220, and a processor 222.

The wallet integration server 102 may be implemented using one or more data processing devices. Further, the wallet integration server 102 may be implemented as a distributed server system where the operations of the wallet integration server 102 may be distributed between one or more data processors and/or a centralized server system where the operations of the wallet integration server 102 may be handled by a single data processor.

As illustrated in FIG. 2, the wallet integration server 102 may include a processor 222. The processor 222 may be a multi-core processor. In another embodiment, the processor 222 may be a combination of multiple single core processors. In one embodiment, the wallet integration server 102 can include a memory 220 coupled to the processor 222. The memory 220 may be non-transitory storage medium, in one embodiment, and a transitory medium in another embodiment. The memory 220 can include instructions that may be executed by the processor 222 to perform operations of the wallet integration server 102. In other words, operations associated with the different engines of the wallet integration server 102 may be executed using the processor 222.

The wallet integration server 102 includes an input/output engine 202 that is configured to enable communication to and from the wallet integration server 102. In particular, the input/output engine 202 is configured to receive input from the user computing device 108, the financial institution server 104, and/or vendor 120. The input received by the input/output engine 202 can include, but is not limited to, credentials associated with the user 106 from the user computing device 108, a selection of one or more vendors from the user computing device 108, a selection of a default payment instrument, a result of the user authentication from either the financial institution server 104 or other authentication agents, a result of the vendor validation of the user from the vendor 120, a notification confirming receipt of payment information from the vendor 120, and payment information associated with the user from the financial institution server 104.

In response to receiving input from the user computing device 108, the financial institution server 104, and/or vendor 120, the wallet integration server 102 may generate one or more outputs for transmission via the input/output engine 202. In particular, the input/output engine 202 may receive credentials associated with the user 106 from the user computing device 108 for authentication of the user 106. Upon receiving the credentials associated with the user 106, the input/output engine 202 may forward the credentials to the authentication engine 204. In one embodiment, the authentication engine 204 may forward the credentials to the financial institution server 104 and/or an authentication agent to authenticate the user 106 based on the credentials. In another embodiment, the wallet integration server 102 may request authentication data associated with the user 106 from the financial institution server 104. In response, the wallet integration server 102 may receive authentication data associated with the user 106 from the financial institution server 104, and compare the authentication data with the credentials received from the user 106 to authenticate the user 106. In some embodiments where the client application of the wallet integration server 102 is integrated with a financial institution system, the user computing device 108 may directly send the credentials of the user 106 to the financial institution server 104 and/or the authentication agent.

If the credentials are forwarded to the financial institution server 104 and/or an authentication agent, a result of the authentication may be sent to the wallet integration server 102 and received by the input/output engine 202 of the wallet integration server 102. Responsive to receiving the result of the authentication, the input/output engine 202 may forwards the result of the authentication to the authentication engine 202. If the result indicates a successful authentication of the user 106, the authentication engine 202 may communicate with the vendor list generation engine 204. The vendor list generation engine 204 in concert with the vendor information database 218 may generate a list of one or more vendors for presentation to the user 106. The vendor information database 218 may include information, such as a vendor code identifying the vendor, associated with any appropriate vendor. Vendors 120 may be added to the vendor information database 218 directly by the wallet integration server 102 or based on request from the vendors 120.

In one example embodiment, the vendor list generation engine 204 may generate a default list of vendors. In another example embodiment, the vendor list generation engine 204 may generate the list of vendors based on vendors that were pre-selected by the user 106 to be included in the list. In yet another example embodiment, the list of one or more vendors may be generated based on transaction history of the user 106, such as bank transaction history, other payment transaction history, and so on. In another example embodiment, the list of one or more vendors may be generated by querying the local connected device, e.g., the user computing device 108 for evidence of using vendor services or having access to certain accounts. Another way of generating the list of one or more vendors includes asking for non-obvious relationships to other accounts based on lack of evidence otherwise.

In either case, once the list of one or more vendors is generated, the input/output engine 202 may transmit the list to the user computing device 108 for presentation to the user 106. The user computing device 108 may prompt the user 106 to make a selection of vendors that need to be updated with payment information associated with the user 106. Responsively, the user 106 may make a selection of at least one vendor from the list of vendors. Data identifying the selected at least one vendor may be transmitted to the wallet integration server 102. Responsive to receiving the data identifying the selected at least one vendor, the input/output engine 202 may communicate with the vendor validation engine 208. The vendor validation engine 208 may generate one or more API calls associated with the selected at least one vendor to route the user 106 to a validation page associated with the selected at least one vendor 120. In other words, the vendor validation engine 208 generates and transmit a validation request to the selected at least one vendor 120 for validation of the user 106 by the selected at least one vendor 120. In one example embodiment, in addition to transmitting the validation request, the vendor validation engine 208 may generate and transmit a unique identifier associated with the user 106 to the selected at least one vendor 120. The unique identifier may be used by the wallet integration server 102 to identity the user 106.

Upon transmitting the validation request, the user computing device 108 may present a validation page associated with the selected at least one vendor 120 to the user 106. Responsively, the user 106 may enter user identification information which may be transmitted to the selected at least one vendor 120 for validation of the user 106. A result of the validation by the selected at least one vendor 120 may be transmitted to the wallet integration server 102. The input/output engine 202 that receives the result of the validation may forward the result to a payment information populate engine 210. If the validation of the user 106 by the selected at least one vendor 120 is successful, the payment information populate engine 210 may associate the user 106 to the selected at least one vendor 120 by mapping or linking the unique identifier of the user 106 to a vendor code associated with the selected at least one vendor 120. In one embodiment, the result of the validation may include the unique identifier associated with the user 106 validated by the selected at least one vendor 120. In one example embodiment, a unique identifier associated with the user 106 may be mapped to one or more vendor codes, each associated with a different vendor. In other words, each user can be associated with multiple vendors. The mapping of the unique identifier associated with the user 106 and the vendor code of the selected at least one vendor 120 may be stored in the vendor-user database 216. The associations stored in the vendor-user database 216 may be used at a later time for automatically updating vendors associated with a user 106 with the payment information associated with the user 106.

Responsive to storing an association of the user 106 with the selected at least one vendor 120, the payment information populate engine 210 may retrieve payment information associated with the user 106 from the financial information database 214. The financial information database 214 may be configured to receive and store payment information associated with a user 106 from the financial institution server 104. Payment information of each user 106 may be mapped to the unique identifier associated with the respective user 106. The financial information database 214 may be dynamically populated or pre-stored with payment information associated with users 106. In some embodiments, the financial information database 214 may be external to the wallet integration server 102 or may be non-existent. In an example embodiment that the financial information database is non-existent, the payment information populate engine 210 may request for payment information associated with the user 106 from the financial institution server 104 as and when a successful validation result is received at the wallet integration server 102.

In either case, responsive to retrieving the payment information associated with the user 106, the payment information populate engine 210 may communicate with the encryption engine 212 to encrypt the payment information or to generate an encrypted message comprising the payment information. After encryption, the payment information associated with the user 106 may be transmitted to the selected at least one vendor 120 via the input/output engine 202.

Upon receipt, the encrypted payment information may be decrypted and stored by the selected at least one vendor 120. Then, the selected at least one vendor 120 transmits a notification confirming the receipt of the payment information to the user computing device 108, the wallet integration server 102, and/or the financial institution server 104.

In one example embodiment, the payment information may include, inter alia, an expiration date associated with a payment instrument of the user 106. For example, the payment information may include a credit/debit card expiration date. The wallet integration server 102 may be configured to track the expiration date and transmit one or more reminder messages to the respective user 106 at pre-determined intervals prior to the expiration date of the payment card. The reminder message may prompt the user 106 to update the payment information or authorize the wallet integration to automatically update the payment information with the vendors 120 upon receiving a new, re-issued, or replaced payment card. Alternatively, the reminder services may be handled by the financial institution server 102, in which case, the bank may send reminders to the user 106 and/or the wallet integration server 102.

The operations of the wallet integration server 102 and the automated payment information update system are described in greater detail below in association with FIGS. 3-5. Accordingly, turning now to FIGS. 3-5, these figures include flow charts that illustrate the process of the automated payment information update system. Although specific operations are disclosed in the flowcharts illustrated in FIGS. 3-5, such operations are exemplary. That is, embodiments of the present invention are well suited to performing various other operations or variations of the operations recited in the flowcharts. It is appreciated that the operations in the flowcharts illustrated in FIGS. 3-5 may be performed in an order different than presented, and that not all of the operations in the flowcharts may be performed.

All, or a portion of, the embodiments described by the flowcharts illustrated in FIGS. 3-5 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the automated payment information system as described below.

Turning to FIG. 3, this figure is a flowchart that illustrates an operation of the wallet integration server in association with an automated payment information update in accordance with an example embodiment. In operation 302, upon receiving credentials associated with the user 106 from the user computing device 108, the wallet integration server 102 may authenticate the user 106. In one embodiment, the wallet integration server 102 may transmit the credentials associated with the user 106 to the financial institution server 104 and/or an authentication agent for authenticating the user 106. Responsively, the financial institution server 104 and/or an authentication agent may authenticate the user 106 and transmit a result of the authentication to the wallet integration server 102. In another embodiment, the wallet integration server 102 may be configured to internally authenticate the user 106 without having to rely on the financial institution server 104 and/or the authentication agent for authenticating the user 106.

In either case, upon successful authentication of the user 106, in operation 304, the wallet integration server 102 may generate a list of one or more vendors for presentation to the user 106. As described above in association with FIGS. 1 and 2, various mechanisms may be used by the wallet integration server 102 to generate the list of the one or more vendors. For example, the list of one or more vendors may be generated using a default group of vendors, or a group of vendors pre-selected by the user. In another example, the list of one or more vendors may be dynamically generated and customized based on transaction history of the user, or queries to user computing device 108, etc. In addition to generating the list of one or more vendors, in some embodiments, the wallet integration server 102 may sort and categorize the list. The sorting and categorizing may be based on user preferences or analysis, such as the vendor with which the user 106 interacts with the most, and so on.

Once the list of one or more vendors is generated and/or customized, in operation 304, the wallet integration server 102 transmits the list to the user computing device 108 for presentation to the user 106. Responsive to transmitting the list to the user computing device, in operation 306 the wallet integration server 102 may receive data identifying at least one vendor 120 selected by the user for transmitting payment information of the user 106. In the event that the user 106 fails to make a selection, the data received by the wallet integration server 102 may identify the same, responsive to which the user computing device 108 continues to prompt the user 106 to make a selection or postpone the selection for a later time.

Upon receiving data identifying at least one vendor 120 selected by the user 106, in operation 308, the wallet integration server 102 generates one or more API calls specific to the selected at least one vendor 120 (herein ‘selected vendor’) to route the user 106 to a validation page associated with the selected vendor 120. Accordingly, the user computing device 108 presents a validation page associated with the selected vendor 120 to the user 106. Further, the user 106 is prompted to input user identification information for validating the user 102. The user identification information may be transmitted to the selected vendor 120, and the selected vendor 120 may validate the user 106. Responsive to validating the user 106, the selected vendor 120 may transmit a result of the validation to the wallet integration server 102. In operation 310, the wallet integration server 102 receives the validation result associated with the validation of the user 106 by the selected vendor 120.

If the user 106 is successfully validated by the selected vendor 120, in operation 312, the wallet integration server 102 may associate the user 106 with the selected vendor 120. Further, the wallet integration server 102 may retrieve, encrypt, and transmit payment information associated with the user to the selected vendor 120. Upon successful receipt of the payment information by the selected vendor 120, the wallet integration server 102 may receive a notification confirming the same. In some embodiments, the wallet integration server 102 may transmit the notification to the user computing device 108 for presentation to the user 106.

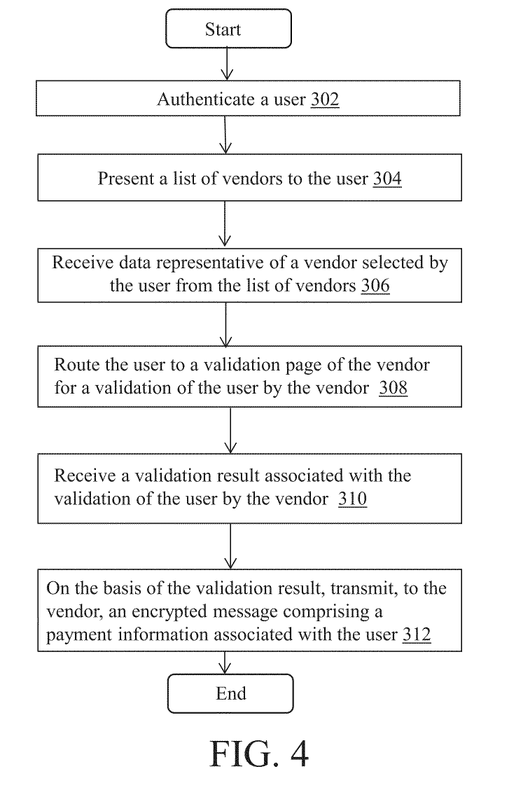

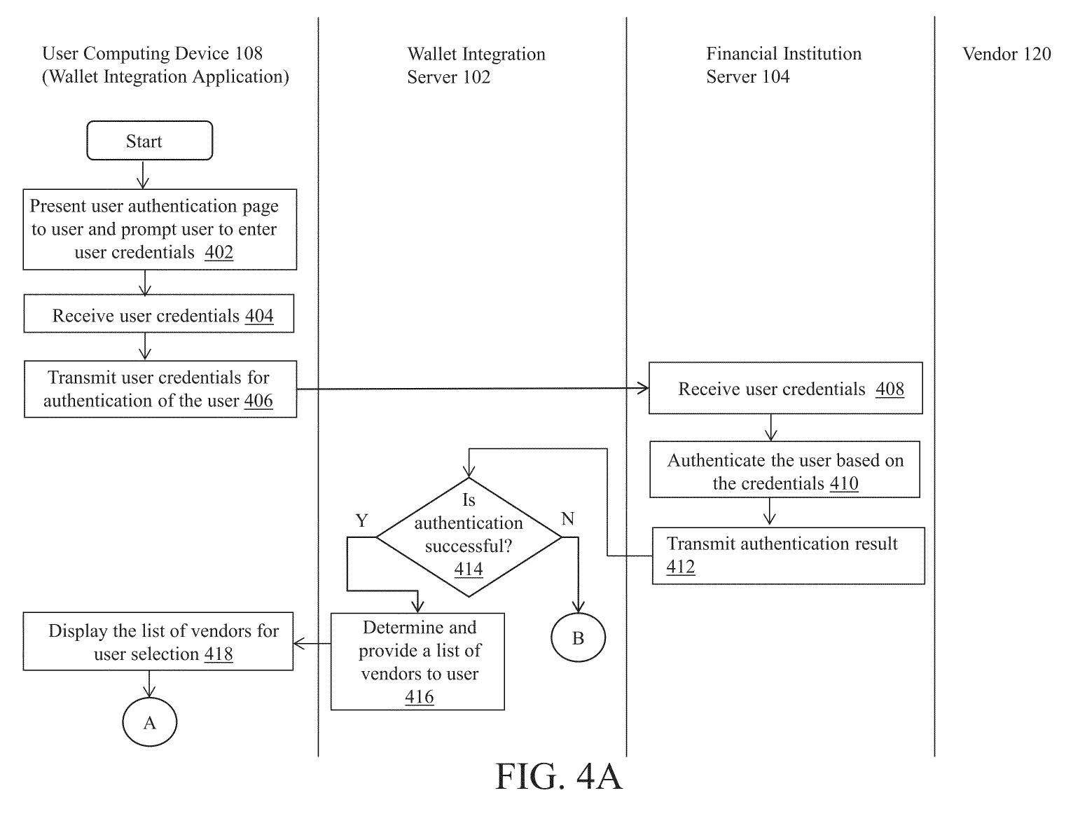

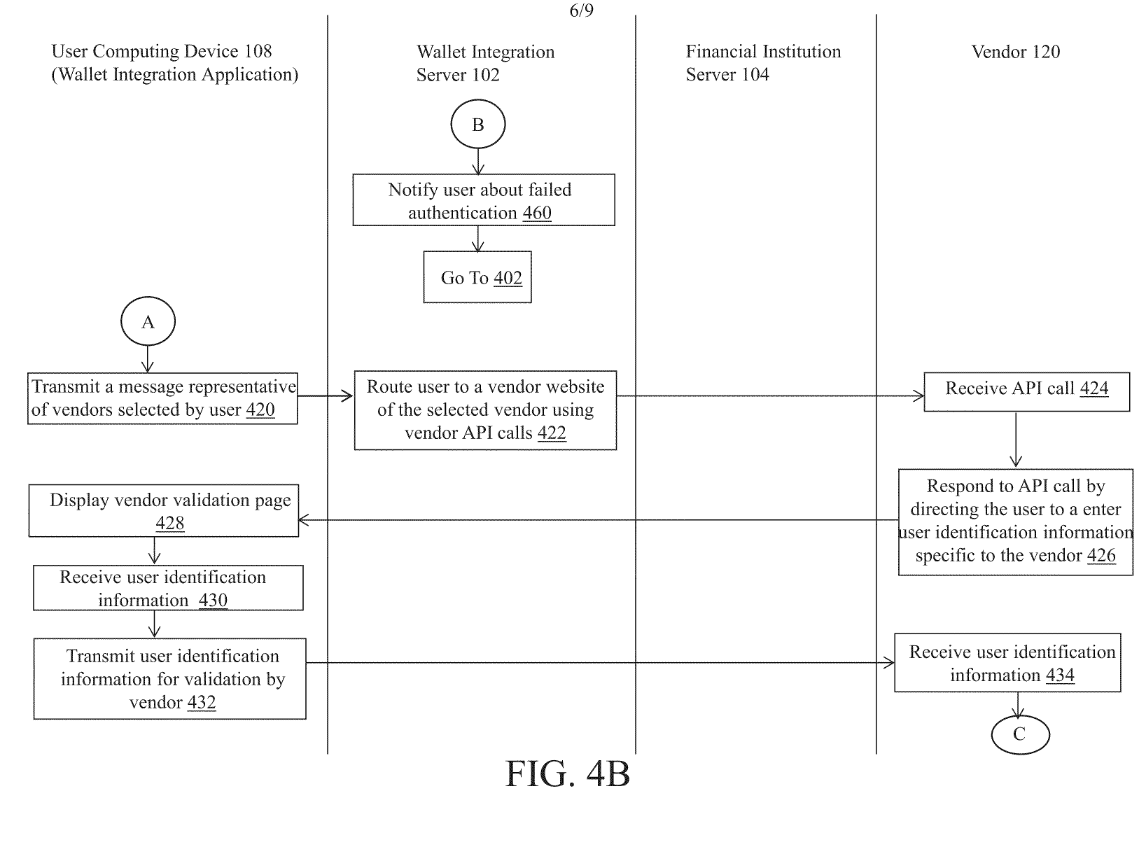

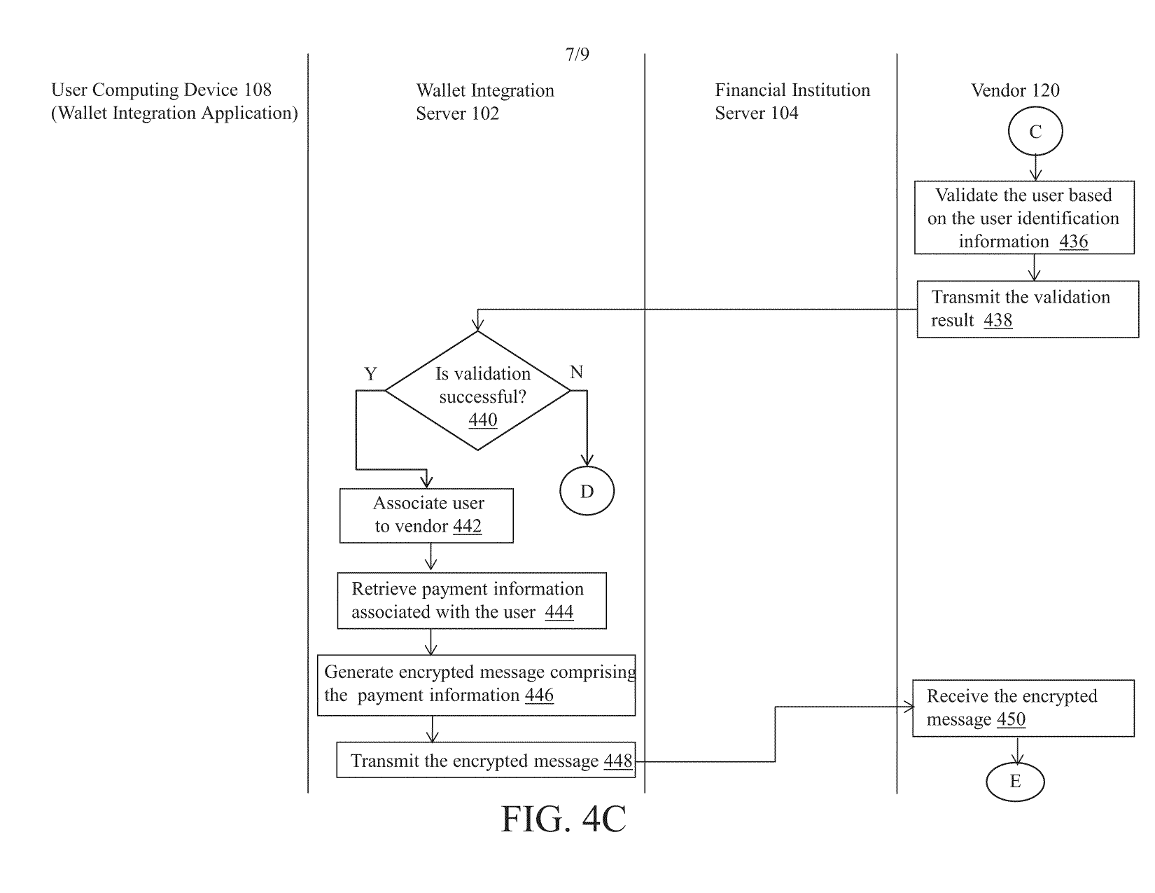

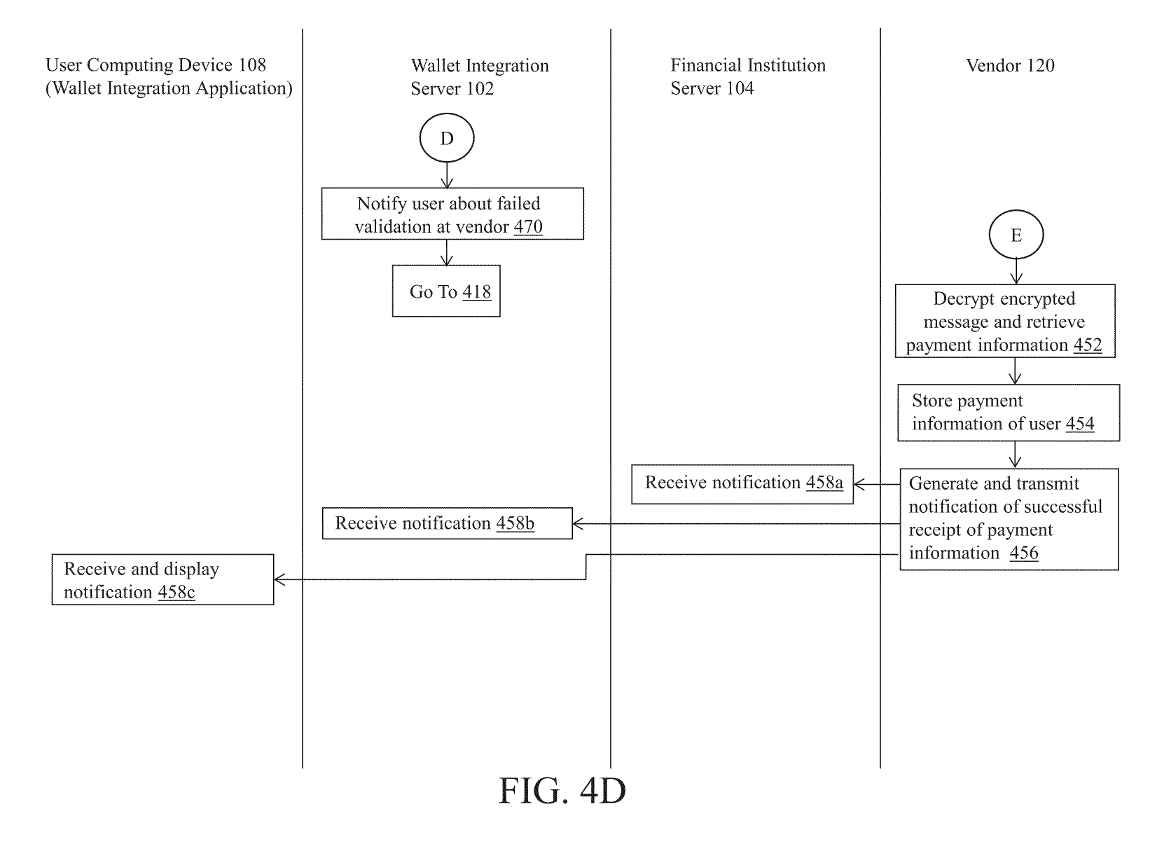

The operations associated with the automated payment information update system and the interactions of the wallet integration server 102 with the user computing device 108, the vendor 120, and/or the financial institution server 104 will be described in greater detail below in association with FIG. 4

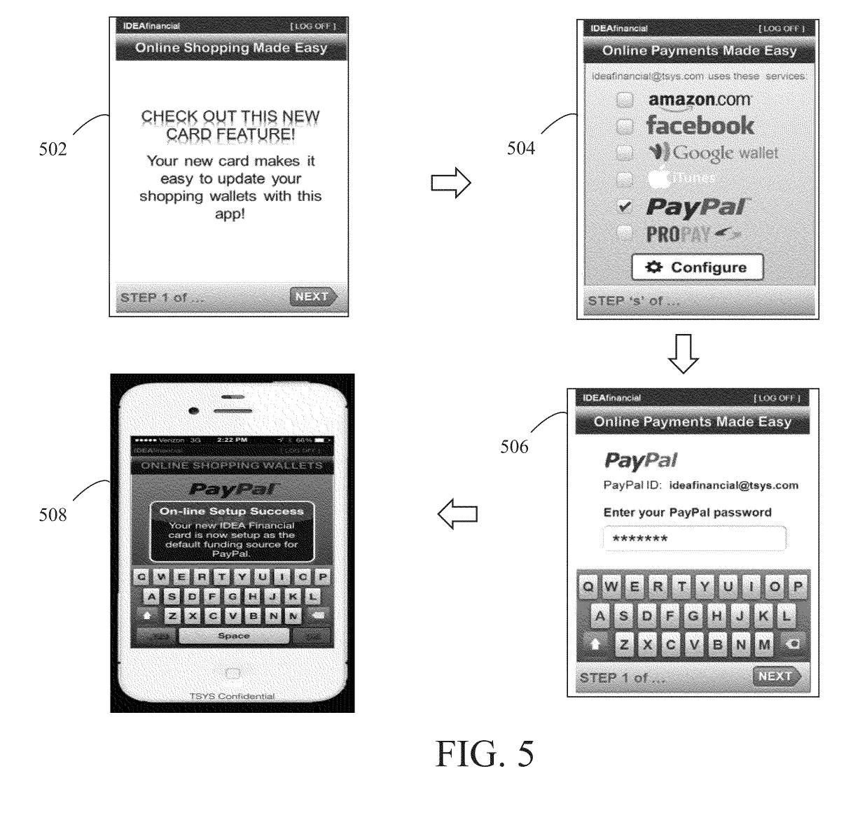

Turning to FIG. 4, this figure is a flowchart that illustrates an operation of payment information update system in accordance with an example embodiment. Further, FIG. 5 illustrates one or more example user interfaces associated with the payment information update process in accordance with an example embodiment. FIG. 4 will be described making exemplary reference FIG. 5 as may be appropriate or helpful.

In operation 402, a client application of the wallet integration server 102 may instruct a user computing device 108 to request for credentials associated with a user 106 to authenticate the user 106. Accordingly, the user computing device 108 prompts the user 106 to input credentials associated with the user 106 for authenticating the user 106. Responsive to prompting, the user 106 may input credentials associated with the user 106, and in operation 404, the user computing device 108 receives the user credentials. Further, in operation 406, the user computing device 108 transmits the user credentials for authentication of the user 106. In one embodiment, the user credentials may be transmitted directly to the financial institution server 104 and/or an authentication agent. In another embodiment, the user credentials may be transmitted to the wallet integration server 102, which in turn may authenticate the user 106 or forward the credentials to the financial institution server 104 and/or an authentication agent that are configured to authenticate the user 106.

In the example embodiment of FIG. 4, the user credentials are transmitted to the financial institution server 104. In operation 408, the financial institution server 104 may receive the user credentials. Further, in operation 410, the financial institution server 104 authenticates the user 106 based on the user credentials. The result of the authentication may be transmitted to the wallet integration server 102, in operation 412. In other words, operations 402-412 illustrate a user authentication process. One of ordinary skill in the art can understand and appreciate that the user authentication process can be a single step authentication process and/or a multi-step authentication process where multiple credentials are requested in sequence or in parallel without departing from a broader scope of the present disclosure. In case of a multi-step authentication, operations 402-408 may be repeated till all the required credentials are required. Once all the required credentials are received, the user 106 may be authenticated in operation 410 and the result may be transmitted to the wallet integration server 102 in operation 412.

Responsive to receiving the result of the authentication, in operation 414, the wallet integration server 102 may determine if the user 106 is successfully authenticated. Upon determining that the user authentication failed, in operation 460, the wallet integration server 102 generates a notification that an authentication of the user 106 has failed. Further, the wallet integration server 102 transmits the notification to the user computing device 108 repeats operation 402 where the user 106 is requested to re-enter credentials associated with the user 106. The process of requesting the user 106 to re-enter credentials associated with the user may be repeated till a successful authentication of the user 106 or till a threshold number of authentication failures.

Returning to operation 414, if the user authentication is successful, in operation 416, the wallet integration server 102 may generate a list of vendors for presentation to the user 106. As described above, the list of vendors may be generated based on a number of factors, such as default group of vendors, pre-selected group of vendors, bank transaction history, and so on. Responsive to generating the list of vendors, the wallet integration server 102 transmits the list to the user computing device 108.

In operation 418, the user computing device 108 may present the list of vendors 504 to the user 106 as illustrated in FIG. 5. In addition, the user computing device 108 prompts the user 106 to make a selection of at least one vendor 120 to receive payment information update. In FIG. 5, the example list of vendors includes a checkbox next to the name of each vendor for selecting the respective vendor. One of ordinary skill in the art can understand and appreciate that a checkbox selection method is only an example, and any other selection or input mechanism may be used without departing from a broader scope of the present disclosure.

Responsive to selecting at least one vendor from the list, in operation 420, the user computing device 108 transmits data identifying the at least one vendor selected by the user (herein ‘selected vendor’) to the wallet integration server 102. Further, in operation 422, the wallet integration server 102 generates one or more API calls associated with the selected vendor 120 for routing the user 106 to a vendor webpage, e.g., validation webpage of the selected vendor 120. In some applications, instead of transmitting data identifying the at least one vendor to the wallet integration server 102, the client application instructs the user computing device 108 to generate the one or more vendor API calls associated with the selected vendor 120. In either case, in operations 424 and 426, the selected vendor 120 receives the API calls and responds by presenting a validation webpage of the selected vendor 120 to the user 106. Accordingly, in operation 428, the user computing device 108 presents the validation webpage 506 (shown in FIG. 5) of the selected vendor 120 to the user 106, and prompts the user 106 to input user identification information for validation of the user 106. For example, as illustrated in FIG. 5, a user 106 selects ‘PayPal®’ from the list of vendors 504. Responsively, PayPal® API's are called and the user 106 is presented with a PayPal® login page requesting user identification information, such as the user's PayPal® identifier and a password for validating the user 106.

Upon receiving user identification information, in operation 432, the user computing device 108 transmits the user identification information to the selected vendor 120. In operations 434 and 436, the selected vendor 120 receives the user identification information and validates the user 106 based on the user identification information. Further, in operation 438, a result of the validation by the selected vendor 120 is transmitted to the wallet integration server 102.

Responsive to receiving the result of the validation, in operation 440, the wallet integration server 102 may determine if the user 106 is successfully validated by the selected vendor 120. Upon determining that the user validation failed, in operation 470, the wallet integration server 102 generates a notification that a validation of the user 106 by the selected vendor has failed. Further, the wallet integration server 102 transmits the notification to the user computing device 108 repeats operation 402 where the user 106 is requested to re-enter user identification information associated with the user 106. The process of requesting the user 106 to re-enter user identification information may be repeated till a successful validation of the user 106 by the selected vendor 120 or till a threshold number of validation failures.

Returning to operation 440, if the validation of the user 106 by the selected vendor 120 is successful, in operation 442, the wallet integration server 102 may associated the user 106 with the selected vendor 120. Further, in operations 444 to 448, the wallet integration server 102 may retrieve, encrypt, and transmit the payment information associated with the user 106 to the selected vendor 120. In operations 450 to 454, the selected vendor 120 receives, decrypts, and stores the payment information associated with the user 106. Responsive to successful receipt of the payment information, in operation 456, the selected vendor 120 may transmit a notification to the financial institution server 104, the wallet integration server 102, and the user computing device 108. Upon receiving the notification, in operation 458c, the user computing device 108 may present the notification 508 to the user 106 as illustrated in FIG. 5.

In one example, bank ABC may offer the automated payment information update service as part of the bank's mobile banking application. That is, the client application of the wallet integration server 102 may be integrated with bank ABC's mobile banking system. A user 106, John Doe may be a customer of the ABC bank. John Doe may be issued a new credit card by the ABC bank. John Doe's payment information, e.g., information associated with newly issued credit card, along with payment information of other customers of the ABC bank may be stored in a financial information database 214 of the wallet integration server 102. The payment information of each customer may be associated with a unique identifier generated for each customer. Accordingly, John Doe may be assigned a unique identifier: 1234.

After issuing the new credit card, the bank may request John Doe to activate John Doe's card by accessing the bank's mobile banking application. Accordingly, John Doe may download a mobile banking application of the ABC bank on John Doe's smart phone. Alternatively, John Doe may access the ABC bank's mobile banking webpage through John Doe's smart phone. In either case, as a part of activating the credit card, the bank may offer John Doe an automated payment information update service as shown in example user interface 502 of FIG. 5. In said example, the user interface 502 may be presented to John Doe after John Doe has been authenticated by the bank and/or after activation of the John Doe's credit card. Accordingly, at the time of presentation of user interface 502, the wallet integration server 102 already knows that John Doe has been successfully authenticated.

If John Doe is interested in receiving the automated payment information update service, then, John Doe may press the ‘Next’ button as shown in user interface 502 of FIG. 5. One of ordinary skill in the art can understand and appreciate that any other appropriate mechanism can be used by John Doe to express John Doe's interest to avail the automated payment information update service. Once John Doe has been authenticated by the ABC bank and/or John Doe has expressed interest in receiving the automated payment information update service, the wallet integration server 102 may generate and transmit a list of vendors to John Doe as shown in example user interface 504 of FIG. 5.

The list may be a default vendor list or a list of vendors that were pre-selected by John Doe. Alternatively, the list may be generated based on John Doe's bank transaction history obtained from ABC bank or by querying John Doe's smart phone for any recent online purchases or transactions with vendors.

In either case, responsive to receiving the list, John Doe selects the vendor PayPal® as illustrated in user interface 504 of FIG. 5. In addition to the list, John Doe may be presented with a request to set the current credit card that is being activated as a default payment card. Accordingly, John Doe can either reject or accept the request to assign the current credit card issued by the ABC bank as John Doe's default payment card.

Upon receiving John Doe's selection of the vendor PayPal®, the wallet integration server 102 or the client application generates one or more PayPal® API calls to route John Doe from the bank's website to PayPal®'s login page as illustrated by example user interface 506 of FIG. 5. The PayPal® login page 506 may be opened within the bank's webpage or as a separate tab taking John Doe outside the bank's webpage. Alternatively, the PayPal® login page may be opened by the operating system of John Doe's smart phone, for example, iOS for Apple iPhone.

Responsive to being presented with the PayPal® login page, John Doe enters the user identification information requested by the PayPal®® login page 506, for example, John Doe's PayPal® identifier, and/or a corresponding password. Further, the user computing device 107 transmits John Doe's user identification information and unique code 1234 to PayPal®. Upon receiving the user identification information, PayPal® may validate the user identification information of the John Doe. After validation, PayPal® may transmit a result of the validation and the unique code 1234 to the wallet integration server 102. If the validation is successful, the wallet integration server may be associated John Doe's unique identifier 1234 with PayPal® and the association may be recorded in the vendor-consumer database 216. Further, the wallet integration server 102 retrieves the payment information associated with John Doe based on the unique identifier 1234. The payment information may be associated with the newly issued credit card and may include the credit card number, expiry date, and the address associated with the credit card. Upon retrieving the payment information, the wallet integration server 102 may encrypt the payment information and transmit the encrypted payment information to PayPal®. PayPal® may decrypt the encrypted payment information and store the payment information for future transactions of John Doe using PayPal®. Further, PayPal® sends a notification to John Doe's smart phone which is presented to John Doe as illustrated using example user interface 508 of FIG. 5. In addition to sending the notification to John Doe's smart phone, PayPal® sends a notification to both the wallet integration server 102 and the ABC bank's server. The notification confirms successful receipt of John Doe's payment information by PayPal®.

In some embodiments, if the wallet integration server 102 may track the expiry date associated with the new credit card, and send reminders to John Doe prior to expiry of the credit card to update the payment information when the credit card is re-issued. Reminders are also sent to John Doe whenever John Doe is issued a new payment instrument, or when an existing payment instrument, such as a payment card is replaced or renewed.

In another example, the client application of the wallet integration server 102 may be offered as a standalone application. Jane Roe may download and install the client application on Jane Roe's tablet. Upon executing the client application, the client application may search the Jane Roe's tablet or may communicate with digital wallet applications on Jane Roe's tablet to identify one or more payment cards used by Jane Roe. One of ordinary skill in the art can understand and appreciate that any other appropriate mechanism can be used by the client application to determine the payment cards associated with Jane Roe. Responsively, the client application may instruct Jane Roe's tablet to present a list of payment cards used by Jane Roe and prompt Jane Roe to assign at least one of the payment cards as a default card. Upon selecting the default payment card, Jane Roe's tablet may prompt Jane Roe to enter credentials associated with Jane Roe for authenticating Jane Roe. The credentials may be sent to the wallet integration server 102 and/or an authentication agent to authenticate Jane Roe based on the credentials. Responsive to successfully authenticating Jane Roe, operations 416-458 may be executed as described in FIG. 4, where Jane Roe is presented a list of vendor, Jane Roe selects at least one vendor from the list, Jane Roe is validated by the selected vendor, payment information associated with Jane Roe's default payment card is transmitted to the selected vendor, and Jane Roe receives a notification confirming safe receipt of the payment information by the selected vendor.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1) A method comprising:
authenticating, by a wallet integration server, a user based on credentials provided by the user;
responsive to a successful authentication of the user, generating, by the wallet integration server, a list of one or more vendors for presentation to the user;
identifying, by the wallet integration server, at least one vendor selected by the user based on data received and representative of the at least one vendor selected by the user from the list of one or more vendors;
responsive to identifying the at least one vendor selected by the user, generating and transmitting, by the wallet integration server, a validation request to the at least one vendor to validate the user;
receiving, by the wallet integration server, a result of the validation of the user by the at least one vendor; and
responsive to a successful validation of the user by the vendor, generating, by the wallet integration server, a message comprising payment information associated with of the user for secure delivery to the at least one vendor.

2) The method of claim 1, further comprising:
transmitting, by the wallet integration server, the encrypted message to the at least one vendor; and
receiving, by the wallet integration server, a notification informing a receipt of the payment information by the vendor.

3) The method of claim 1, further comprising: responsive to a successful validation of the user by the vendor, associating, by the wallet integration server, the user with the at least one vendor by mapping a unique identifier associated with the user to an identifier associated with the at least one vendor.

4) The method of claim 1, wherein transmitting the validation request to the at least one vendor to validate the user further comprises generating an application programming interface (API) call associated with the at least one vendor to route the user to a validation page associated with the vendor.

5) The method of claim 1, wherein the payment information is encrypted for secure delivery to the at least one vendor.

6) The method of claim 1, wherein authenticating the user based on credentials provided by the user further comprises:
receiving, by the wallet integration server, the credentials associated with the user;
transmitting, by the wallet integration server, the credentials to an authentication agent for authenticating the user; and
receiving, by the wallet integration server, a result of the authentication of the user.

7) The method of claim 6, wherein the authentication agent is a financial institution associated with the user.

8) The method of claim 1, wherein the list of one or more vendors is generated based on a transaction history associated of the user.

9) The method of claim 1, wherein the list of one or more vendors is pre-selected by the user.

10) A system comprising:
a network; and
a wallet integration server communicably coupled to the network and configured to:
authenticate, by an authentication engine of the wallet integration server, a user based on credentials provided by the user;
responsive to a successful authentication of the user, generate, by a vendor list generation engine of the wallet integration server, a list of one or more vendors for presentation to the user;
responsive to receiving a selection of at least one vendor from the list of one or more vendors by the user, transmit, by a vendor validation engine of the wallet integration server, a validation request to the at least one vendor to validate the user;
responsive to a successful validation of the user by the at least one vendor, generate, by a populate engine of the wallet integration server, a message comprising payment information associated with the user for delivery to the at least one vendor; and
receiving a notification representative of a successful receipt of the payment information by the at least one vendor.

11) The system of claim 10, wherein to authenticate the user, the wallet integration server is configured to:
receive the credentials associated with the user;
transmit the credentials to an authentication agent for authenticating the user; and
receive a result of the authentication of the user.

12) The system of claim 10, wherein the payment information is encrypted for secure delivery to the at least one vendor.

13) The system of claim 10, wherein to transmit the validation request to the at least one vendor to validate the user, the wallet integration server is configured to generate an application programming interface (API) call associated with the at least one vendor to route the user to a validation page associated with the vendor.

14) The system of claim 10, wherein the wallet integration server is configured to generate and transmit reminders to the user for updating the payment information associated with the user in the event of a change in the payment information.

15) An apparatus comprising:
a vendor list generation engine operable to generate a list of one or more vendors for presentation to a user in response to a successful authentication of the user;
a vendor validation engine operable to generate and transmit a validation request to at least one vendor for validating the user by the at least one vendor, wherein the at least one vendor is selected by the user from the list of one or more vendors; and
a populate engine operable to generate and transmit a message comprising payment information associated with the user to the at least one vendor in response to a successful validation of the user by the at least one vendor.

16) The apparatus of claim 15, comprising: an encryption engine operable to encrypt the payment information for secure delivery of the payment information to the at least one vendor.

17) The apparatus of claim 15, wherein the vendor list generation engine is operable to generate the list of one or more vendors based on a transaction history associated of the user.

18) The apparatus of claim 15, wherein the vendor validation engine is operable to generate an application programming interface (API) call associated with the at least one vendor to route the user to a validation page associated with the vendor.

19) A method comprising:
prompting, by a user computing device, a user to input credentials associated with the user for authenticating the user;
receiving, by the user computing device, credentials associated with the user;
transmitting, by the user computing device, the credentials associated with the user for authenticating the user by an authentication agent;
responsive to a successful authentication of the user, presenting a list of one or more vendors to the user;
prompting the user to select at least one vendor from the list of one or more vendors;
receiving an input representative of the at least one vendor selected by the user;
responsive to receiving the at least one vendor selected by the user, presenting validation instructions associated with the at least one vendor;
prompting the user to enter user identification information of the user for validation of the user by the at least one vendor; and
responsive to a successful validation of the user and transfer of payment information associated with the user to the vendor, receiving a notification informing a receipt of the payment information by the vendor.
